(19) United States
(12) Patent Application Publication
(10) Pub. No.: US 2006/0116502 A1
(43) Pub. Date: Jun. 1, 2006

(54) Blocked polyisocyanates and their use in dual-cure coating compositions

(75) Inventors: Christoph Gurtler, Koln (DE); Markus Mechtel, Bergisch Gladbach (DE); Jan Weikard, Odenthal (DE); Nusret Yuva, Burscheid (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/287,752

(22) Filed: Nov. 28, 2005

(30) Foreign Application Priority Data
Nov. 30, 2004 (DE) 102004057916.4

(51) Int. Cl. C08G 18/00

(52) U.S. Cl. 528/44

(57) ABSTRACT

The present invention relates to blocked polyisocyanates containing at least one radiation-curable groups and at least one structural unit of the formula (II) 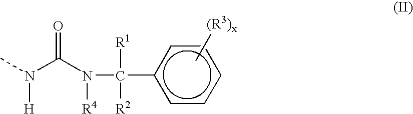 wherein
R¹, R² and R³ independently of one another are hydrogen or a C₁-C₄ alkyl radical or a cycloalkyl radical,
R⁴ is a C₁-C₄ alkyl, C₆-C₁₀ cycloalkyl or C₇-C₁₄ aralkyl radical and x is an integer from 1 to 5. The present invention also relates to a process for preparing these blocked polyisocyanates and to dual-cure coating, adhesive or sealant compositions containing these polyisocyanates.

### BACKGROUND OF THE INVENTION

1. Field of the Invention

The present invention relates to new polyisocyanate crosslinkers for dual-cure systems and also to their preparation and use.

2. Description of Related Art

Coating compositions which cure by two independent processes are referred to as dual-cure systems. Customarily the binder components present possess different functional groups, which under suitable conditions, generally independently of one another, undergo crosslinking with one another. Customary prior-art dual-cure systems possess radiation-curable and thermally curable groups, with particularly advantageous properties being obtained when using isocyanate groups and hydroxyl groups as the thermally crosslinking groups.

EP-A 0 928 800 describes a dual-cure system which comprises a crosslinker that contains both radiation-curable acrylate groups and isocyanate groups, which can be cured thermally using suitable binders, e.g. OH-containing binders. Since NCO groups and OH groups react with one another at room temperature, the aforementioned coating system can be employed only as a two-component system, in which NCO-containing and NCO-reactive constituents are mixed with one another shortly before or during the coating operation. The disadvantage of a very short processing life for these systems can be eliminated by blocking the free NCO groups. The combination of such radiation-curable and heat-curable systems containing blocked isocyanate groups is described for example in EP-A-126 359, WO-A 01/42329 or U.S. Pat. No. 4,961,960.

In the case of the majority of prior art blocked polyisocyanates the blocking agents present are eliminated during the crosslinking reaction and then released. In that case it is necessary for the blocking agents used to depart from the coating as fully as possible after baking, so as not adversely to affect the quality of the coating film. The resulting coatings should be lightfast and show no yellowing on baking.

Depending on the blocking agent used, the scratch resistance and acid stability of one-component (1K) coating films are generally poorer than in the case of two-component (2K) polyurethane coating systems (e.g. T. Engbert, E. König, E. Jürgens, Farbe & Lack, Curt R. Vincentz Verlag, Hannover October 1995). The elimination of the blocking agent and its gaseous escape from the paint film may also lead to blistering in the paint in the case of inappropriate blocking agents.

The major compounds used to block polyisocyanates are ε-caprolactam, methyl ether ketoxime (butanone oxime), diethyl malonate, secondary amines, triazole derivatives and pyrazole derivatives, as described, for example, in EP-A 0 576 952, EP-A 0 566 953, EP-A 0 159 117, U.S. Pat. No. 4,482,721, WO 97/12924 or EP-A 0 744 423.

For particularly low crosslinking temperatures of 90 to 120° C., use has been made more recently of diethyl malonate-blocked ioscyanates (e.g. EP-A 0 947 531). In contrast to blocking with N-heterocyclic compounds, such as caprolactam or butanone oxime, in this case the full blocking agent is not eliminated; instead, in the course of curing, there is transesterification on the diethyl malonate, with elimination of ethanol. A disadvantage, however, is that, because of the labile ester bond, such systems are extremely susceptible to acid exposure, and so the application possibilities of these products are limited.

3,5-dimethylpyrazole (DMP)-blocked isocyanates are products with a great diversity of possible uses which are distinguished by very low yellowing of the coating on baking and overbaking and which undergo deblocking at low temperatures of <130° C.

Secondary amine blocking agents are described in EP-A 0 096 210, the focus apparently being on secondary dialkyl amines. Although the amines specified therein do include aralkyl-substituted amines, EP-A 096 210 does not explicitly describe any compounds of that kind. Also, it is disclosed that secondary amines are not all suitable, i.e., only those of the invention from EP-A 096 210.

DE-A 3434881 and EP-A 0 787 754 describe solid blocked polyisocyanates as curatives for powder coating compositions. The blocking agents specified include aralkyl-substituted secondary amines such as tert-butyl-benzylamine. These coating compositions cure at less than 170° C. and even on baking, overbaking and weathering show no tendency towards discoloration. References to the use of such blocking agents in liquid or aqueous coating compositions, which are normally prepared, processed and cured at significantly lower temperatures of preferably <130° C., are absent.

Aralkyl-substituted secondary amines, such as N-tert-butyl-N-benzylamine, are described as blocking agents for polyisocyanates in thermosetting liquid coating applications, in EP-A 1 375 550, EP-A 1 375 551 and EP-A 1 375 552. The systems are distinguished by improved yellowing stability compared to butanone oxime, and by lower baking temperatures, and in these respects have properties approximately comparable with those of DMP-blocked polyisocyanates.

For dual-cure systems, where curing takes place by way of two crosslinking mechanisms which proceed separately from one another, and where in general a thermal curing operation and a photochemical curing operation take place, not all of the blocking agents known from the chemistry of thermal curing are equally suitable for producing low-yellowing coatings. While DMP-blocked polyisocyanates exhibit outstanding bake and overbake yellowing stability in coating compositions which cure by means of heat alone, coatings based on dual-cure polyisocyanates, which in addition to the radiation-curable groups contain DMP-blocked NCO groups, exhibit an unsatisfactorily high degree of yellowing, especially on overbake, after the thermal and photochemical curing operations have taken place.

It is an object of the present invention to provide polyisocyanates for dual-cure systems which besides the radiation-curable groups for photochemically initiated crosslinking also contain blocked NCO groups for thermal curing. It is an additional object of the present invention to provide coating composition having a baking temperature of below 130° C., wherein the resulting coatings are distinguished by particularly low yellowing, even on overbake.

It has now been found that this object may be achieved with polyisocyanates of the present invention which contain NCO groups blocked with secondary amines of formula I) 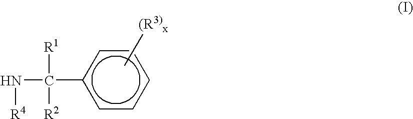
wherein
R¹, R² and R³ independently of one another are hydrogen, a C₁-C₄ alkyl radical or a cycloalkyl radical,
R⁴ is a C₁-C₄ alkyl, C₆-C₁₀ cycloalkyl or C₇-C₁₄ aralkyl radical, and
x is an integer from 1 to 5.

### SUMMARY OF THE INVENTION

The present invention relates to blocked polyisocyanates containing at least one radiation-curable group and at least one structural unit of the formula (II) 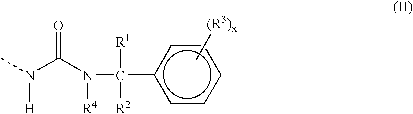
wherein
R¹, R² and R³ independently of one another are hydrogen or a C₁-C₄ alkyl radical or a cycloalkyl radical,
R⁴ is a C₁-C₄ alkyl, C₆-C₁₀ cycloalkyl or C₇-C₁₄ aralkyl radical and
x is an integer from 1 to 5.

The present invention also relates to a process for preparing these blocked polyisocyanates by reacting
A1) one or more organic polyisocyanates with
A2) one or more compounds which contain at least one isocyanate-reactive group and at least one radiation-curable group,
A3) optionally isocyanate-reactive compounds other than A2) and
A4) blocking agents of formula I) 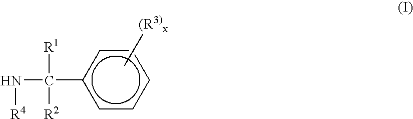
   wherein
R¹, R² and R³ independently of one another are hydrogen or a C₁-C₄ alkyl radical or a cycloalkyl radical,
R⁴ is a C₁-C₄ alkyl, C₆-C₁₀ cycloalkyl or C₇-C₁₄ aralkyl radical and
x is an integer from 1 to 5.

The present invention also relates to dual-cure coating, adhesive or sealant compositions containing the polyisocyanates of the invention.

### DETAILED DESCRIPTION OF THE INVENTION

In accordance with the present invention a radiation-curable group is a group which on exposure to actinic radiation reacts, with polymerization, with ethylenically unsaturated compounds. Actinic radiation means electromagnetic, ionizing radiation, especially electron beams, UV rays and visible light (Roche Lexikon Medizin, 4th Edition; Urban & Fischer Verlag, Munich 1999).

Radiation-curable groups are understood for the purposes of the present invention to include vinyl ether, maleinyl, fumaryl, maleimide, dicyclopentadienyl, acrylamide, acrylic and methacrylic groups; preferably vinyl ether, acrylate and/or methacrylate groups and more preferably acrylate groups.

Preferred isocyanate-reactive groups for the purposes of the invention are hydroxyl, amino, aspartate or thiol groups, more preferably hydroxyl groups.

Suitable compounds for use as component A1) include all organic compounds containing isocyanate groups, preferably aliphatic, cycloaliphatic, aromatic or heterocyclic polyisocyanates with an NCO functionality≧2, individually or in admixture with one another. It is unimportant whether they have been prepared by phosgenation or by phosgene-free processes.

Also highly suitable are the polyisocyanates adducts prepared from monomeric polyisocyanates and containing uretdione, carbodiimide, isocyanurate, iminooxadiazinedione, biuret, urethane, allophanate, oxadiazinetrione or acylurea groups and polyisocyanate prepolymers with an average NCO functionality >1, which may be obtained by preliminary reaction of a molar excess of one of the preceding monomeric polyisocyanates or polyisocyanate adducts with an organic compounds containing at least two isocyanate-reactive groups, e.g., in the form of OH groups.

Examples of monomeric aliphatic and cycloaliphatic isocyanates which are present in A1) or on which the higher molecular weight polyisocyanate adducts or polyisocyanate prepolymers of component A1) may be prepared include 1,4-diisocyanatobutane, 1,5-diisocyanatopentane, 1,6-diisocyanatohexane (HDI), 2-methyl-1,5-diisocyanatopentane, 1,5-diisocyanato-2,2-dimethylpentane, 2,2,4- and 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane (Desmodur® W, Bayer AG, Leverkusen), 4-isocyanatomethyl-1,8-octane diisocyanate (triisocyanatononane, TIN), ω,ω′-diisocyanato-1,3-dimethylcyclohexane (H₆XDI), 1-isocyanato-1-methyl-3-isocyanatomethylcyclohexane, 1-isocyanato-1-methyl-4-isocyanato-methylcyclohexane and bis(isocyanatomethyl)norbornane.

Examples of monomeric aromatic isocyanates include 1,5-naphthalene diisocyanate, 1,3- and 1,4-bis(2-isocyanato-prop-2-yl)benzene (TMXDI), 2,4- and 2,6-diisocyanatotoluene (TDI) and mixtures of these isomers, 2,4′- and 4,4′-diisocyanatodiphenylmethane (MDI), 1,5-diisocyanatonaphthalene, 1,3-bis(isocyantomethyl)benzene (DXI).

For the purposes of the invention it is preferred in A1) to use compounds having a number average molecular weight of 140 to 1000 g/mol and containing aliphatically, cycloaliphatically, araliphatically and/or aromatically bound isocyanate groups. More preferred for use in component A1) are polyisocyanates or polyisocyanate mixtures containing exclusively aliphatically and/or cycloaliphatically bound isocyanate groups, particularly those based on hexamethylene diisocyanate (HDI), isophorone diisocyanate (IPDI) and/or 4,4′-diisocyanatodicyclohexylmethane.

Suitable for use as component A2) are all compounds, individually or in admixture, which contain at least one isocyanate-reactive group and at least one radiation-curable group of the type defined herein. Most preferably these compounds are hydroxy-functional acrylates and methacrylates.

Suitable hydroxy-functional acrylates or methacrylates include compounds such as 2-hydroxyethyl (meth)acrylate, polyethylene oxide mono(meth)acrylates, polypropylene oxide mono(meth)acrylates, polyalkylene oxide mono(meth)acrylates, poly(ε-caprolactone) mono(meth)acrylates (such as Tone®M100, Union Carbide, USA), 2-hydroxypropyl (meth)acrylate, 4-hydroxybutyl (meth)acrylate, 3-hydroxy-2,2-dimethylpropyl (meth)acrylate, the hydroxy-functional mono-, di- or tetraacrylates of polyhydric alcohols (such as trimethylolpropane, glycerol, pentaerythritol or dipentaerythritol); ethoxylated, propoxylated or alkoxylated trimethylolpropane, glycerol, pentaerythritol or dipentaerythritol; and mixtures thereof. Also suitable are alcohols which can be obtained from the reaction of double-bond-containing acids with optionally double-bond-containing monomeric epoxide compounds, such as the reaction products of (meth)acrylic acid with glycidyl (meth)acrylate or with the glycidyl ester of Versatic acid (Cardura E10, Resolution Nederland BV, part of Shell BV, NL).

Suitable for use as component A3) are hydrophilic compounds having at least one isocyanate-reactive group, individually or in admixture. Hydrophilic compounds are used especially when the polyisocyanates of the invention are to be dispersed or dissolved in water or water-containing mixtures.

Hydrophilic compounds include all ionic and nonionic hydrophilic compounds having at least one isocyanate-reactive group. Preferred isocyanate-reactive groups are hydroxyl and/or amino functions.

Preferred hydrophilic ionic compounds are compounds which contain at least one isocyanate-reactive group and also at least one functionality, such as —COOY, —SO₃Y or —PO(OY)₂ (wherein Y is H, NH₄⁺ or a metal cation); or —NR₂, —NR₃⁺, or —PR₃⁺ (wherein R is H, alkyl or aryl), which on interaction with aqueous media enter into an optionally pH-dependent dissociation equilibrium and thus may carry a negative, positive or neutral charge.

Examples of suitable hydrophilic ionic compounds are mono- and dihydroxycarboxylic acids, mono- and diaminocarboxylic acids, mono- and dihydroxysulphonic acids, mono- and diaminosulphonic acids, mono- and dihydroxyphosphonic acids or mono- and diaminophosphonic acids and the salts thereof. Examples include dimethylolpropionic acid, dimethylolbutyric acid, hydroxypivalic acid (HPA), N-(2-aminoethyl)-β-alanine, 2-(2-aminoethylamino)-ethanesulphonic acid, ethylenediamine-propyl- or butylsulphonic acid, 1,2- or 1,3-propylenediamine-β-ethylsulphonic acid, malic acid, citric acid, glycolic acid, lactic acid, glycine, alanine, taurine, N-cyclohexyl-3-aminopropiosulphonic acid (CAPS), lysine, 3,5-diaminobenzoic acid, an adduct of IPDI and acrylic acid (EP-A 0 916 647, Example 1) and its alkali metal and/or ammonium salts, the adduct of sodium bisulphite with but-2-ene-1,4-diol, polyethersulphonate, the propoxylated adduct of 2-butenediol and NaHSO₃ (described for example in DE-A 2 446 440, page 5-9, formula I-III), and units which can be converted into cationic groups such as N-methyldiethanolamine. Preferred ionic or potential ionic compounds are those which contain carboxyl or carboxylate and/or sulphonate groups and/or ammonium groups. More preferred ionic compounds are those which contain carboxyl and/or sulphonate groups as ionic or potential ionic groups, particularly the salts of HPA, CAPS, N-(2-aminoethyl)-β-alanine, 2-(2-aminoethylamino)ethanesulphonic acid, the adduct of IPDI and acrylic acid (EP-A 0 916 647, Example 1) and dimethylolpropionic acid.

As hydrophilic nonionic compounds it is possible to use compounds having a polyether structure, preferably alkylene oxide-based polyethers, which contain at least one hydroxyl or amino group as their isocyanate-reactive group.

These compounds with a polyether structure include monofunctional polyalkylene oxide polyether alcohols containing on average 5 to 70, preferably 7 to 55 ethylene oxide groups per molecule and containing at least 30 mol % of ethylene oxide, based on the total moles of alkylene oxides, such as those obtained in known manner by alkoxylating suitable starter molecules (e.g. in Ullmanns Encyclopädie der technischen Chemie, 4th Edition, Volume 19, Verlag Chemie, Weinheim pp. 31-38).

Examples of suitable starter molecules include saturated monoalcohols such as methanol, ethanol, n-propanol, isopropanol, n-butanol, isobutanol, sec-butanol, the isomers pentanols, hexanols, octanols and nonanols, n-decanol, n-dodecanol, n-tetradecanol, n-hexadecanol, n-octadecanol, cyclohexanol, the isomeric methyl-cyclohexanols or hydroxymethylcyclohexane, 3-ethyl-3-hydroxymethyloxetane, tetrahydrofurfuryl alcohol; diethylene glycol monoalkyl ethers such as diethylene glycol monobutyl ether; unsaturated alcohols such as allyl alcohol, 1,1-dimethylallyl alcohol or oleyl alcohol; aromatic alcohols such as phenol, the isomeric cresols or methoxyphenols; araliphatic alcohols such as benzyl alcohol, anisyl alcohol or cinnamyl alcohol; secondary monoamines such as dimethylamine, diethylamine, dipropylamine, diisopropylamine, dibutylamine, bis-(2-ethylhexyl)amine, N-methyl- and N-ethylcyclohexylamine or dicyclohexylamine; and also heterocyclic secondary amines such as morpholine, pyrrolidine, piperidine or 1H-pyrazole. Preferred starter molecules are saturated monoalcohols. It is particularly preferred to use diethylene glycol monobutyl ether as the starter molecule.

Alkylene oxides that are suitable for the alkoxylation reaction are, in particular, ethylene oxide and propylene oxide, which can be used in any order, sequentially or in admixture, during the alkoxylation reaction so that block polyethers or mixed polyethers are obtained.

The compounds with a polyether structure are preferably straight polyethylene oxide polyethers or mixed polyalkylene oxide polyethers, wherein at least 30 mole %, preferably at least 40 mole %, of the alkylene oxide units are ethylene oxide units. Especially preferred are monofunctional mixed polyalkylene oxide polyethers which contain at least 40 mole % of ethylene oxide units and not more than 60 mole % of propylene oxide units.

Additionally as compounds of component A3) it is possible to use low molecular weight mono-, di- or polyols such as short-chain (i.e., containing 2 to 20 carbon atoms) aliphatic, araliphatic or cycloaliphatic monoalcohols, diols, or triols. Examples of monoalcohols include methanol, ethanol, the isomeric propanols, butanols, pentanols, diacetone alcohol, fatty alcohols or fluorinated alcohols such as those available under the name Zonyl® from DuPont. Examples of diols include ethylene glycol, diethylene glycol, triethylene glycol, tetraethylene glycol, dipropylene glycol, tripropylene glycol, 1,2-propanediol, 1,3-propanediol, 1,4-butanediol, neopentyl glycol, 2-ethyl-2-butylpropanediol, trimethylpentanediol, positionally isomeric diethlyoctanediols, 1,3-butylene glycol, cyclohexanediol, 1,4-cyclohexanedimethanol, 1,6-hexanediol, 1,2- and 1,4-cyclohexanediol, hydrogenated bisphenol A (2,2-bis(4-hydroxycyclohexyl)propane) and 2,2-dimethyl-3-hydroxypropyl-2,2-dimethyl-3-hydroxypropionate. Examples of triols include trimethylolethane, trimethylolpropane or glycerol. Preferred alcohols are 1,4-butanediol, 1,4-cyclohexanedimethanol, 1,6-hexanediol and trimetholpropane.

Preferably, the monools, diols or triols are optionally used in amounts <0.3, more preferably <0.1 equivalent per equivalent of isocyanate. Most preferably monools, diols or triols are not used.

Preferred for use as component A4) are the blocking agents of formula I) wherein
R¹, R² and R³ are hydrogen,
R⁴ is a methyl, ethyl, isopropyl or tert-butyl group, preferably a tert-butyl group, and
x is an integer from 1 to 5.

Examples of these blocking agents include N-tert-butyl-N-benzylamine, N-isopropyl-N-benzylamine, N-ethyl-N-benzylamine, N-methyl-N-benzylamine, and N-isopropyl-N-(dimethyl)benzylamine.

It is possible as component A4) to use the required amines both in admixture with one another and in admixture with other blocking agents. Examples of these other blocking agents include alcohols, lactams, oximes, malonic esters, alkyl acetoacetates, triazoles, phenols, imidazoles, pyrazoles and also amines. Examples include butanone oxime, diisopropylamine, 1,2,4-triazole, dimethyl-1,2,4-triazole, imidazole, diether malonate, ethyl acetate, acetone oxime, 3,4-dimethylpyrazole, ε-caprolactam, N-methyl-, N-ethyl-, N-(iso)propyl-, N-n-butyl-, N-isobutyl- or 1,1-dimethylbenzylamine, N-alkyl-N-1,1-dimethylmethylphenylamine, adducts of benzylamine with compounds having activated double bonds such as malonic esters, N,N-dimethylaminopropylbenzylamine, other optionally substituted benzylamines containing tertiary amino groups, dibenzylamine, and mixtures of these blocking agents. If used at all, these other blocking agents are used in amounts to up to 80%, preferably up to 60% and more preferably up to 20% by weight, based on the weight of component A4). Most preferably N-tert-butyl-N-benzylamine is exclusively used as the blocking agent in component A4).

The equivalent ratio of free isocyanate groups to be blocked to the blocking agent from A4) is 1:0.8 to 1:1.2, preferably 1:1. Preferably 0.2 to 0.8 equivalent of A4), more preferably 0.3 to 0.7 equivalent of A4), is used per equivalent of NCO in A1). Preferably 0.2 to 0.8 equivalent of A2), more preferably 0.3 to 0.7 equivalent of A2), is used per equivalent of NCO in A1). The amount of free NCO groups in the polyisocyanates of the invention is <5%, preferably <0.5% and more preferably <0.1%, by weight.

Besides components A1) to A4) it is possible to use all compounds that are known to catalyze NCO blocking, individually or in admixture. Preferred are catalytically active Lewis acids or catalytically active amines, such as are commonly used in polyurethane chemistry. Particularly preferred catalysts for the blocking reaction are organic tin and inorganic bismuth catalysts such as bismuth ethylhexanoate, or dibutyltin dilaurate, DBTL. Zinc catalysts may also be used. The amount of catalyst is typically 0.05 to 10%, preferably 0.1 to 3% and more preferably 0.2 to 1% by weight, based on the nonvolatile fraction of the polyisocyanate to be prepared.

It is also possible additionally to use the additives, or mixtures thereof, that are known from polyurethane chemistry and from the chemistry of ethylenically unsaturated coating compositions. Preference is given to using stabilizers in order to avoid premature polymerization, in an amount of 0.01% to 1%, preferably 0.1% to 0.5% by weight, based on the amount of unsaturated groups. Suitable inhibitors are described for example in Houben-Weyl, Methoden der organischen Chemie, 4th Edition, Volume XIV/1, Georg Thieme Verlag, Stuttgart 1961, page 433 ff.

Examples include sodium dithionite, sodium hydrogen sulphide, sulphur, hydrazine, phenylhydrazine, hydrazobenzene, N-phenyl-β-naphthylamine, N-phenylethanoldiamine, dinitrobenzene, picric acid, p-nitrosodimethylamine, diphenylnitrosamine, phenols (such as para-methoxyphenol, 2,5-di-tert-butylhydroquinone, 2,6-di-tert-butyl-4-methylphenol, p-tert-butyl-pyrocatechol or 2,5-di-tert-amylhydroquinone), tetramethylthiuram disulphide, 2-mercaptobenzothiazole, dimethyldithiocarbamic acid, sodium salt, phenothiazine, N-oxyl compounds such as 2,2,6,6-tetramethylpiperidine N-oxide (TEMPO) or one of its derivatives. The stabilizers can also be incorporated chemically, in which case compounds of the preceding classes are suitable in particular if they also contain free aliphatic alcohol groups or primary or secondary amine groups such that they constitute stabilizers bonded chemically via urethane groups or urea groups. Particularly suitable for this purpose is 2,2,6,6-tetramethyl-4-hydroxypiperidine N-oxide. In one preferred version an oxygen-containing gas which is dry, preferably air, is passed in during the preparation of the polyisocyanates of the invention.

The polyisocyanates of the invention can be prepared in bulk (without solvent) or in the presence of suitable solvents or reactive diluents. Suitable solvents include the known coating solvents, such as butyl acetate, methoxypropyl acetate, acetone, methyl ethyl ketone, N-methylpyrrolidone, solvent naphtha (from Exxon-Chemie, as an aromatic-containing solvent), and mixtures of these solvents. Blocking is preferably performed in these solvents at a preferred solids content between 10% and 90%.

Examples of suitable reactive diluents are the known compounds from radiation curing (cf. Römpp Lexikon Chemie, p. 491, 10th Ed. 1998, Georg-Thieme-Verlag, Stuttgart), particularly those having low hydroxyl contents of less than 30, preferably less than 10 mg KOH/g. Examples include the esters of acrylic acid or methacrylic acid, preferably of acrylic acid, with the following alcohols. Monohydric alcohols include the isomeric butanols, pentanols, hexanols, heptanols, octanols, nonanols and decanols; cycloaliphatic alcohols such as isobomol, cyclohexanol and alkylated cyclohexanols or dicyclopentanol; arylaliphatic alcohols such as phenoxyethanol and nonylphenylethanol; and tetrahydrofurfuryl alcohols. It is also possible to use alkoxylated derivatives of these alcohols. Dihydric alcohols include ethylene glycol, propane-1,2-diol, propane-1,3-diol, diethylene glycol, dipropylene glycol, the isomeric butanediols, neopentyl glycol, hexane-1,6-diol, 2-ethylhexanediol, tripropylene glycol and alkoxylated derivatives of these alcohols. Preferred dihydric alcohols are hexane-1,6-diol, dipropylene glycol and tripropylene glycol. Alcohols with a higher functionality include glycerol, trimethylolpropane, ditrimethylolpropane, pentaerythritol, dipentaerythritol and their alkoxylated derivatives.

The polyisocyanates of the invention are preferably prepared at a temperature of 25 to 180° C., more preferably 30 to 90° C. In one preferred embodiment of the invention component A1) is introduced initially and is reacted at temperatures of 30 to 150° C. with A2), optionally A3) and optionally A4) until the NCO content has fallen to the desired level. Components A2) to A4) can be added individually in any order or as a mixture. It is preferred to add them as a mixture. During the reaction of the stated components a dry, oxygen-containing gas, preferably air, is preferably passed through the reaction medium.

It is also possible to introduce A2), A3) and A4) initially and to meter in A1). Initially introducing A2), A3), A4) or a mixture of two of these components, then metering in A1) and, finally, adding the remaining constituents A2), A3) and/or A4) is also possible.

The optional additives can be added at the beginning, during or after the addition of A2), A3) or A4). Preferably they are added immediately after A4). If present, solvents or reactive diluents, particularly if stabilizers are included, are added at least partly prior to the addition of A2). Solvents are preferably added before or after the end of the reaction. If the solvent reacts with isocyanates, it is advantageous not to add the solvent until the reaction has ended or until the NCO content has dropped below 1% by weight.

When the polyisocyanates of the invention are intended to be part of a coating composition that is solid on application, such as a powder coating composition, then the polyisocyanates of the invention should preferably be either amorphous, with a glass transition temperature of 20 to 90° C., preferably 30 to 65° C., or crystalline, with a melting point of 30 to 130° C., preferably 60 to 120° C. Polyisocyanates for this application may be obtained by the use of compounds having cycloaliphatic groups during the preparation of the polyisocyanates of the invention. For this application it is preferred to use cycloaliphatic diisocyanates in component A1).

The dual-cure systems based on the polyisocyanates of the invention are suitable for producing coatings, adhesive bonds and sealants.

Also suitable for use in accordance with the present the invention are dual-cure compositions which contain a mixture of polyisocyanates that contain NCO groups blocked with the blocking agents specified under A4), but which do not contain any radiation-curable groups, and blocked polyisocyanates which contain at least one radiation-curable group, but do not contain NCO groups blocked with the blocking agents specified under A4).

In the dual-cure compositions of the invention it is possible for blocked polyisocyanates to be present which do not contain any radiation-curable groups. These polyisocyanates are based on the isocyanates already mentioned above in connection with component A1) and are blocked with the blocking agents specified in A4). The preparation of these polyisocyanates is known.

In the dual-cure compositions of the invention it is also possible for one or more compounds to be present which contain at least one isocyanate-reactive group and optionally one or more radiation-curable groups. These compounds may be monomeric, oligomeric or polymeric and contain at least one, preferably two or more, isocyanate-reactive group(s).

Examples of these compounds include low molecular weight, short-chain (i.e. containing 2 to 20 carbon atoms) aliphatic, araliphatic or cycloaliphatic diols or triols. Examples of diols include ethylene glycol, diethylene glycol, triethylene glycol, tetraethylene glycol, dipropylene glycol, tripropylene glycol, 1,2-propanediol, 1,3-propanediol, 1,4-butanediol, neopentyl glycol, 2-ethyl-2-butylpropanediol, trimethylpentanediol, positionally isomeric diethyloctanediols, 1,3-butylene glycol, cyclohexanediol, 1,4-cyclohexanedimethanol, 1,6-hexanediol, 1,2- and 1,4-cyclohexanediol, hydrogenated bisphenol A (2,2-bis(4-hydroxycyclohexyl)propane), 2,2-dimethyl-3-hydroxypropyl 2,2-dimethyl-3-hydroxypropionate. Examples of suitable triols include trimethylolethane, trimethylolpropane or glycerol. Suitable alcohols of higher functionality include ditrimethylolpropane, pentaerythritol, dipentaerythritol or sorbitol.

Also suitable are higher molecular weight polyols such as polyester polyols, polyether polyols, hydroxy-functional acrylic resins, hydroxy-functional polyurethanes or corresponding hybrids (cf. Römpp Lexikon Chemie, pp. 465-466, 10th Ed. 1998, Georg-Thieme-Verlag, Stuttgart).

Also suitable are the compounds set forth under A2) and also isocyanate-reactive, oligomeric or polymeric, unsaturated compounds containing acrylate and/or methacrylate groups, alone or in combination with the preceding monomeric compounds. Preferred are the hydroxyl-containing polyester acrylates having an OH content of 30 to 300 mg KOH/g, preferably 60 to 200 and more preferably 70 to 120. The preparation of these polyester acrylates is described in DE-A 4 040 290 (p. 3, 1.25-p. 6, 1.24), DE-A-3316592 (p. 5, 1.14-p. 11, 1.30) and P. K. T. Oldring (Ed.), Chemistry & Technology of UV & EB Formulations For Coatings, Inks & Paints, Vol. 2, 1991, SITA Technology, London, pp. 123-135.

It is also possible to use the known hydroxyl-containing epoxy (meth)acrylates having OH contents of 20 to 300 mg KOH/g, preferably of 100 to 280 mg KOH/g and more preferably of 150 to 250 mg KOH/g; hydroxyl-containing polyurethane (meth)acrylates having OH contents of 20 to 300 mg KOH/g, preferably of 40 to 150 mg KOH/g and more preferably of 50 to 100 mg KOH/g; and mixtures thereof with one another and mixtures with hydroxyl-containing unsaturated polyesters, mixtures with polyester (meth)acrylates or mixtures of hydroxyl-containing unsaturated polyesters with polyester (meth)acrylates.

These compounds are described in P. K. T. Oldring (Ed.), Chemistry & Technology of UV & EB Formulations For Coatings, Inks & Paints, Vol. 2, 1991, SITA Technology, London pp. 37-56. Hydroxyl-containing epoxy (meth)acrylates are based in particular on reaction products of acrylic acid and/or methacrylic acid with epoxides (glycidyl compounds) of monomeric, oligomeric or polymeric bisphenol A, hydrogenated bisphenol A, bisphenol F, hexanediol and/or butanediol or their ethoxylated and/or propoxylated derivatives.

The curable compositions of the invention may also contain compounds having radiation-curable groups and that contain neither NCO groups nor NCO-reactive groups. These compounds can be used in amounts up to 75%, preferably less than 50% by weight, based on the curable composition. Preferably, however, these compounds are not used.

Examples of such compounds are polymers such as polyacrylates, polyurethanes, polysiloxanes, and compounds having radiation-curable groups. Examples of such compounds include the known reactive diluents from radiation curing (cf. Römpp Lexikon Chemie, p. 491, 10th Ed. 1998, Georg-Thieme-Verlag, Stuttgart) or the binders that are known from radiation curing, such as polyether acrylates, polyester acrylates, urethane acrylates, epoxy acrylates, provided that they have a hydroxyl group content of less than 30, preferably less than 20 and more preferably less than 10 mg KOH/g.

Examples include esters of acrylic acid or methacrylic acid as a constituent of B4), preferably acrylic acid, with the alcohols that follow. Monohydric alcohols include the isomeric butanols, pentanols, hexanols, heptanols, octanols, nonanols and decanols, and also cycloaliphatic alcohols such as isobomol, cyclohexanol and alkylated cyclohexanols, dicyclopentanol, arylaliphatic alcohols such as phenoxyethanol and nonylphenylethanol, and also tetrahydrofurfuryl alcohols. It is also possible to use alkoxylated derivates of these alcohols. Dihydric alcohols include alcohols such as ethylene glycol, propane-1,2-diol, propane-1,3-diol, diethylene glycol, dipropylene glycol, the isomeric butanediols, neopentyl glycol, hexane-1,6-diol, 2-ethylhexanediol, tripropylene glycol and alkoxylated derivatives of these alcohols. Preferred dihydric alcohols are hexane-1,6-diol, dipropylene glycol and tripropylene glycol. Alcohols with a higher functionality include glycerol, trimethylolpropane, ditrimethylolpropane, pentaerythritol, dipentaerythritol or their alkoxylated derivatives.

It is possible for the compounds that are known to catalyze NCO blocking to be present in the curable compositions of the invention. Preferred are catalytically active Lewis acids or catalytically active amines, such as are commonly used in polyurethane chemistry. Particularly preferred catalysts for the blocking reaction are organic tin and inorganic bismuth catalysts such as bismuth ethylhexanoate, or dibutyltin dilaurate, DBTL. Zinc catalysts may also be used.

The amount of the catalyst can be adapted to the requirements of curing, taking into account curing temperature. Suitable amounts are 0.01 to 2%, preferably 0.05 to 1%, and more preferably 0.07 to 0.6%, by weight of catalyst, based on total solids content. When curing is to take place at relatively high baking temperatures, i.e., at about 160° C. or above, it may be possible to carry out in the absence of a catalyst.

Additionally present may be the known additives of varnishes, paints, printing inks, sealants and adhesives. These include initiators which can be activated by actinic radiation and which trigger free-radical polymerization of the corresponding polymerizable groups. Photoinitiators activated by UV or visible light are preferred. Photoinitiators are known and include both unimolecular (type I) and bimolecular (type II) initiators. Suitable (type I) systems include aromatic ketone compounds, e.g. benzophenones in combination with tertiary amines, alkylbenzophenones, 4,4′-bis(dimethylamino)benzophenone (Michler's ketone), anthrone, halogenated benzophenones or mixtures thereof. Also suitable are (type II) initiators such as benzoin and its derivatives, benzil ketals, acylphosphine oxides such as 2,4,6-trimethylbenzoyldiphenylphosphine oxide, bisacylphosphine oxides, phenylglyoxylic esters, camphorquinone, α-aminoalkylphenones, α,α-dialkoxyacetophenones and α-hydroxyalkylphenones. Where the coating composition of the invention is to be processed on an aqueous basis, it is preferred to use photoinitiators which can be readily incorporated into aqueous coating compositions. Examples of such products include Irgacure® 500, Irgacure® 819 DW (Ciba, Lampertheim, DE) and Esacure® KIP (Lamberti, Aldizzate, Italy). Mixtures of these compounds can also be used.

When the curing of the polymerizable constituents is to be initiated thermally, suitable initiators include peroxy compounds such as diacyl peroxides, benzoyl peroxide, alkyl hydroperoxides such as diisopropylbenzene monohydroperoxide, alkyl peresters such as tert-butyl perbenzoate, dialkyl peroxides such as di-tert-butyl peroxide, peroxydicarbonates such as dicetyl peroxide dicarbonate, inorganic peroxides such as ammonium peroxodisulphate or potassium peroxodisulphate, azo compounds such as 2,2′-azobis[N-(2-propenyl)-2-methylpropionamide], 1-[(cyano-1-methylethyl)azo]formamide, 2,2′-azobis(N-butyl-2-methylpropionamide), 2,2′-azobis(N-cyclohexyl-2-methylpropionamide), 2,2′-azobis{2-methyl-N-[2-(1-hydroxybutyl)]propionamide}, 2,2′-azobis{2-methyl-N-[2-(1-hydroxybutyl)propionamide, 2,2′-azobis {2-methyl-N-[1,1-bis(hydroxymethyl)-2-hydroxyethyl]propionamide, and benzpinacol. Preferred for aqueous coating systems are compounds which are water-soluble or are present in the form of aqueous emulsions. These free-radical initiators can be combined in a known way with accelerators.

Additives which can additionally be used are the stabilizers described above in connection with the preparation of the polyisocyanates of the invention, light stabilizers such as UV absorbers and sterically hindered amines (HALS), antioxidants, fillers, paint additives such as anti-settling agents, defoaming and/or wetting agents, flow control agents, reactive diluents, plasticizers, catalysts, auxiliary solvents and/or thickeners, pigments, dyes and/or matting agents. The use of light stabilizers and the various types are described in A. Valet, Lichtschutzmittel für Lacke, Vincentz, Verlag, Hanover, 1996.

The curable compositions of the invention are typically prepared by mixing the constituents of the coating composition with one another in any order at temperatures of −20 to 120° C., preferably 10 to 90° C. and more preferably 20 to 60° C. The coating composition in this case may at room temperature be solid, liquid, in solution or in dispersion. The solid coating compositions are prepared with the known equipment from powder coating technology, in particular using extruders, mills and classifiers. For liquid, dissolved or dispersed coating compositions the known agitator mechanisms and dispersion equipment from the coating technology of liquid systems are suitable.

In the compositions of the invention the ratio of blocked isocyanate groups to isocyanate-reactive groups in B3) is preferably 0.5 to 2, more preferably 0.8 to 1.5 and most preferably 1:1.

The coating compositions of the invention can be applied by known techniques to a wide variety of substrates, such as spraying, rolling, knife coating, pouring, squirting, brushing, impregnating or dipping. Examples of suitable substrates include wood, metal, including in particular metal as used in wire, coil, can or container coating, and also plastic, especially ABS, AMMA, ASA, CA, CAB, EP, UF, CF, MF, MPF, PF, PAN, PA, PE, HDPE, LDPE, LLDPE, UHMWPE, PET, PMMA, PP, PS, SB, PUR, PVC, RF, SAN, PBT, PPE, POM, PUR-RIM, SMC, BMC, PP-EPDM, and UP (abbreviations in accordance with DIN 7728 part 1), paper, leather, textiles, felt, glass, electronic assemblies or mineral substrates. It is also possible to coat substrates which are composed of various materials from among those stated, or substrates which have already been coated. It is also possible to apply the coating compositions to a substrate only temporarily, then to cure them partly or fully and to detach them again, in order to produce sheets.

The applied film thicknesses (prior to curing) are typically between 0.5 and 5000 μm, preferably between 5 and 1 500 μm and more preferably between 15 and 1000 μm.

Radiation curing is carried out preferably by exposure to high-energy radiation, i.e. UV radiation or daylight, e.g. light with a wavelength of 200 to 750 nm, or by bombardment with high-energy electrons (electron beams, 150 to 300 keV). Examples of radiation sources used for light or UV light include high-pressure mercury vapor lamps. It is possible for the mercury vapor to have been modified by doping with other elements such as gallium or iron. Lasers, pulsed lamps (known under the designation UV flashlight lamps), halogen lamps or excimer emitters are also suitable. The lamps may be stationary so that the material to be irradiated is moved past the radiation source by means of a mechanical apparatus, or the lamps may be mobile and the material to be irradiated remains stationary in the course of curing. The radiation dose that is normally sufficient for crosslinking in the case of UV curing is 80 to 5000 mJ/cm².

Irradiation can also be carried out in the absence of oxygen, such as under an inert gas atmosphere or oxygen-reduced atmosphere. Suitable inert gases are preferably nitrogen, carbon dioxide, noble gases or combustion gases. Irradiation can also take place with the coating covered with media that are transparent to radiation. Examples include polymeric films, glass or liquids such as water.

The nature and concentration of any initiator used are to be varied in known manner in accordance with the radiation dose and curing conditions.

Particular preference is given to carrying out curing using high-pressure mercury lamps in stationary installations. Photoinitiators are then used in concentrations of 0.1 to 10%, preferably 0.2 to 3.0% by weight, based on the solids content of the coating. These coatings are preferably cured using a dose of 200 to 3000 mJ/cm² as measured in the wavelength range from 200 to 600 nm.

The coating compositions of the invention additionally cure by exposure to thermal energy. This thermal energy can be introduced by radiation, thermal conduction and/or convection into the coating. It is customary to use the known ovens, near-infrared lamps and/or infrared lamps from coating technology. Supplying thermal energy triggers the crosslinking reaction of the blocked isocyanate groups with the isocyanate-reactive groups of the coating composition.

Since through exposure to actinic radiation and the generation of thermal energy two independent chemical mechanisms are set in operation, the sequence of actinic radiation/thermal energy and hence the sequence in which the mechanisms unfold can be combined arbitrarily. It is preferred initially to remove any organic solvent and/or water that is present, using known methods from coating technology. In one preferred version, curing is carried out wholly or partly by exposure to actinic radiation. Immediately thereafter or later, and in the same place or elsewhere, the thermal cure can take place. In this way it is possible, for example, first to produce flexible coatings, which withstand deformation of the substrate without damage, and then to subject these coatings to further, thermal curing. Thus it is possible to coat metal which has already been coated, in the form of what are known as coils, and to cure the coatings initially by exposure to actinic radiation to give a flexible coating. Particular parts can then be detached from the coated coils by known methods, such as by punching, and can be brought mechanically into a new form without the coating suffering damage or tearing. Subsequently, by means of thermal energy, the crosslinking reaction of the blocked isocyanate groups with the isocyanate-reactive groups of the coating composition is triggered, thereby producing highly resistant coatings which are suitable, inter alia, as clearcoat materials for car bodies or for parts used in car construction.

In another embodiment initially a polymeric film is coated and the coating is cured by actinic radiation to give a layer which is resistant to blocking but elastic. This film can subsequently be drawn over a molding and bonded to it. This thermoforming, as it is known, takes place preferably at elevated temperatures. During or after the forming operation the temperature is reached that is necessary for the crosslinking of the blocked isocyanate groups with the isocyanate-reactive groups of the coating composition such that the coating crosslinks to a highly resistant layer.

In another embodiment it is also possible initially to carry out crosslinking by thermal energy and then further to crosslink the surfaces of the resulting coated substrate or the part containing the coating composition of the invention by exposure to actinic radiation at temperatures of 0 to 300° C., preferably 23 to 200° C. and more preferably 80 to 150° C. In particular it can be advantageous to combine the method of thermal curing of coatings, known as in-mold coating, with a subsequent crosslinking by actinic radiation outside the mold.

The invention is further illustrated but is not intended to be limited by the following examples in which all parts and percentages are by weight unless otherwise specified.

### EXAMPLES

Unless otherwise stated, all percentages are to be understood as being percent by weight (% by weight).

The free NCO group content was determined by titration in accordance with DIN EN ISO 11909 (titration with dibutylamine).

The viscosities were determined at 23° C. using a rotational viscometer (ViscoTester® 550 and Haake PK 100, Thermo Haake GmbH, D-76227 Karlsruhe).

Measurement was carried out on a Perkin Elmer Paragon 1000 FT-IR instrument. It was carried out between NaCl plates. The substances undergoing measurement were not diluted further.

Desmodur® N3300: HDI polyisocyanate with isocyanurate groups, NCO content of 21.8%, viscosity 3000 mPas/23° C., Bayer AG, Leverkusen, DE

Desmophen® A 870: Polyacrylate polyol, OH content about 2.95% based on as-supplied form, 70% in butyl acetate, Bayer AG, Leverkusen, DE

Desmophen® VP LS 2089: Polyester polyol, OH content: about 6% based on as-supplied form, 75% in butyl acetate, Bayer AG, Leverkusen, DE

Tinuvin 292: Light stabilizer for coatings, Ciba AG, Basle, CH

Tinuvin 400: Light stabilizer for coatings, Ciba AG, Basle, CH

BYK 306: Silicon surface additive, BYK-Chemie GmbH, Wesel, DE

Irgacure 184/Luc. TPO: Photoinitiator from Ciba (Basle, CH), Lucirin TPO—Photoinitiator from BASF (Ludwigshafen, DE).

### Comparison Example 1

### DMP-Blocked, Acrylate-Functional Polyisocyanate

A 1000 ml four-necked flask with reflux condenser and internal thermometer was charged with 366.7 g (1.9 eq) of Desmodur® N3300 (NCO content 21.8%, equivalent weight 192.7 g) and 162.4 g of butyl acetate (solids content of the finished product: 80%). To the mixture was added 0.36 g of 2,6-di-tert-butyl-4-methylphenol (ionol) as stabilizer. The mixture was stirred to homogeneity and brought to a temperature of 60° C. At this temperature 113.2 g (1.18 eq) of 3,5-dimethylpyrazole were added and the mixture was stirred until the NCO content reached the theoretical level. At this point 0.0064 g of tin octoate was added. Additionally, over the course of 15 minutes, 169.7 g (0.72 eq) of a 1:1 adduct of glycidyl methacrylate and acrylic acid with a hydroxyl number of 235 mg KOH/g were added. The mixture was held at a temperature of 60° C. until the NCO content of the reaction reached zero. Testing took place by IR spectroscopy, detectable through the decrease in the band at 2260 cm⁻¹ (band for isocyanate groups) in the IR spectrum. The color number of the product was about 53 Apha, the viscosity at 23° C. was 4470 mPas, the blocked NCO content was 6.09% and the equivalent weight, based on blocked isocyanate, was 689.7 g/eq.

### Example 2

### Blocked, Acrylate-Functional Polyisocyanate According to Invention

A 1000 ml four-necked flask with reflux condenser and internal thermometer was charged in a nitrogen atmosphere with 366.7 g (1.90 eq) of Desmodur® N3300 (NCO content 21.8%, equivalent weight 192.7 g) and 182.2 g of butyl acetate (solids content of the finished product: 80%). As stabilizers the mixture received 0.373 g each of ionol and triphenylphosphine. The mixture was stirred to homogeneity and over the course of 60 minutes 192.4 g (1.18 eq) of N-tert-butyl-N-benzylamine (equivalent weight 163.3 g) were added dropwise. During this addition the reaction temperature was maintained below 45° C. by means of water-bath cooling. After the end of the addition of amine the mixture was stirred further at 45° C. for 15 minutes until the theoretical NCO content was reached. 50 ppm of DBTL were added to the N-tert-butyl-N-benzylamine blocked polyisocyanate and over the course of 15 minutes 169.7 (0.0.72 eq) of a 1:1 adduct of glycidyl methacrylate and acrylic acid with a hydroxyl number of 235 mg KOH/g were added. The mixture was heated to 60° C. and held at this temperature until the NCO content of the reaction reached zero. Testing took place by IR spectroscopy, detectable through a decrease in the band at 2260 cm⁻¹ (band for isocyanate groups) in the IR spectrum. The color number of the product was 17 Apha, the viscosity at 23° C. was 7780 mPas, the blocked NCO content was 5.43% and the equivalent weight, based on blocked isocyanate, was 773.5 g.

### USE EXAMPLES

For examination of the performance, coating films were produced starting from each of the polyisocyanates prepared in Example 1 and Example 2, respectively, and these films were cured under conditions which were varied. The composition of the coating compositions is set forth in the table below:

| | Eq. weight | 2 | 1 |
|---|---|---|---|
| Component A | | | |
| Desmophen ® A 870 | 576 | 58.6 | 63.4 |
| Desmophen ® VP LS 2089 | 283 | 54.7 | 59.2 |
| Tinuvin 292, as-supplied form | | 2.6 | 2.6 |
| Tinuvin 400, 50% BA | | 5.3 | 5.3 |
| BYK 306, as-supplied form | | 1.3 | 1.3 |
| Irgacure 184/Luc. TPO, 50% in BA | | 7.9 | 7.9 |
| Butyl acetate | | 141.5 | 140.1 |
| Interim total: | | 272.0 | 279.9 |
| Component B | | | |
| Polyisocyanate from Example 2 | 774 | 228.0 | |
| Polyisocyanate from Example 1 | 690 | | 220.1 |
| Total: | | 500.0 | 500.0 |
| Solids content | | 55% | 55% |

Production of Coating Films on Glass, Metal Coil-Coat Sheet, and Metal Sheet for the Gradient Oven

For the purpose of determining the general coating properties, coating compositions 1 and 2 were applied to glass plates using a bone-shaped 100 μm manual coater.

To determine the coating properties such as initial yellowing, overbake yellowing and yellowing increase, coating compositions 1 and 2 were applied using a bone-shaped 100 μm manual coater to metal coil-coat sheet (coated with solvent-borne “Polarweiss” white basecoat material).

To test the resistance to tree resin, brake fluid Hydraulan 400, pancreatin, sodium hydroxide solution (NaOH) and sulphuric acid (H₂SO₄), the finished coating composition was applied to steel panels (420 mm×98 mm), which were produced specifically for use in the gradient oven (see also sample preparation for determinations in the gradient oven).

The results of the overall coating determinations are set forth in the table below.

All of the coatings were freed from solvent in a drying oven at 50° C. for 15 minutes. The UV lamp used was an instrument from IST Strahlentechnik, Nürtingen, DE, with irradiation taking place at 1500 mJ/cm² (CK lamp, 80 W/cm). After UV irradiation and/or thermal curing had concluded, the König pendulum hardness was determined in each case after 60 minutes at room temperature.

Following application, the finished coating compositions were flashed off at 80° C. for 10 minutes, after which two of each of the curing methods described below took place, in different sequences:

a) UV irradiation (CK 1500 mJ/cm²)+17 min 120° C. thermal cure

b) UV irradiation+17 min 140° C. thermal cure

c) 17 min 120° C. thermal cure+UV irradiation

d) 17 min 140° C. thermal cure+UV

The results of coatings testing are set forth below:

| | Example | | | | | | | |
|---|---|---|---|---|---|---|---|---|
| | 1a | 1b | 1c | 1d | 2a | 2b | 2c | 2d |
| Curing | a) | b) | c) | d) | a) | b) | c) | d) |
| Flow time, DIN 4 | 22 s | 22 s | 22 s | 22 s | 21 s | 21 s | 21 s | 21 s |
| GLAS: Film optical qualities | Clear | Clear | Clear | Clear | Clear | Clear | Clear | Specks |
| Pendulum hardness, sec. | 153 s | 200 s | 201 s | 205 s | 123 s | 182 s | 175 s | 192 s |
| FAM^{[1]} | 0/0 | 0/0 | 0/0 | 0/0 | 0/0 | 0/0 | 0/0 | 0/0 |
| Initial yellowing^{[2]} | 1.7/2.1 | 1.9/2.3 | 1.4/1.5 | 1.2/1.6 | 2.7/2.8 | 4.6/4.9 | 1.5/1.8 | 1.4/1.9 |
| Overbake yellowing^{[3]} | 2.6/3.5 | 3.3/4.4 | 3.7/4.5 | 4.4/6.2 | 4.6/4.9 | 6.3/6.9 | 4.6/4.9 | 4.7/6.3 |
| Yellowing increase^{[4]} | 0.9/1.4 | 1.4/2.1 | 2.3/3.0 | 3.2/4.6 | 1.9/2.1 | 1.7/2.0 | 3.1/3.1 | 3.3/4.4 |
| Scratch resistance^{[5]} | 91/43 | 91/57 | 91/59 | 90/62 | 92/54 | 92/56 | 91/59 | 90/58 |
| Gloss reflow 2 h 60° C.^{[6]} | 57 | 73 | 72 | 74 | 60 | 64 | 68 | 68 |
| Delta gloss/reflow^{[7]} | 48/34 | 34/18 | 32/19 | 28/16 | 38/32 | 36/28 | 32/23 | 32/22 |
| Relative residual gloss/reflow %^{[8]} | 47/63 | 63/80 | 65/79 | 69/82 | 59/65 | 61/70 | 65/75 | 64/76 |
| DB test (after h)^{[9]} | 1 h | 1 h | 1 h | 1 h | 1 h | 1 h | 1 h | 1 h |
| Chemical resistance: | | | | | | | | |
| Solvent^{[10]} | 0155 | 0004 | 0001 | 0001 | 0005 | 0001 | 0002 | 0001 |
| Tree resin^{[11]} | 56 | >68 | 58 | 68 | >68 | >68 | >68 | >68 |
| Pancreatin^{[12]} | 36 | 36 | 36 | 36 | 36 | 36 | 36 | 36 |
| NaOH, 1%^{[13]} | 36 | 36 | 36 | 36 | 36 | 36 | 36 | 36 |
| H₂SO₄, 1%^{[14]} | 36-39* | 36-43* | 36-38* | 36-43 | 36 | 36 | 36 | 36*-40 |
| DOI-before/after^{[15]} | 80/70 | 80/80 | 80/80 | 80/80 | 80/80 | 80/80 | 80/80 | 80/80 |
| Haze before/after^{[16]} | 8/19 | 9/12 | 8/12 | 9/10 | 8/90 | 9/12 | 9/10 | 20/23 |
| Blistering (size/amount) | 5/1 | None | None | None | 5/2 | 2/1 | 1/1 | None |

^{[1]}: FAM (Fachausschuβ Mineral und Brennstoffnormung) [Technical Committee, Minerals and Fuels Standardization) is a term from the car industry for a specific petroleum spirit/solvent combination which is used to test the resistance of bodywork coatings.

The test composition used, following the general guidelines of DIN 51 604 (part 1), is FAM test fuel of the following composition:

| | |
|---|---|
| 50% by volume | xylene |
| 30% by volume | isoctane |
| 15% by volume | diisobutylene |
| 5% by volume | ethanol |

Procedure and Assessment:

A cotton-wool pad soaked for about 10 seconds in the test fuel was placed on the sample panel and immediately covered with a watch glass or the like. After 10 minutes the pad was removed and the area was wiped with a soft cloth and assessed:
^{[2-4]}: After the clearcoat materials had been baked the yellowness value b was determined in accordance with DIN 6174 (CIELAB). Thereafter the coating composition was overbaked for 30 minutes at a temperature higher by 20° K than the baking temperature, and again the yellowness value was determined. The difference in the two yellowness values (delta b) is a measure of the thermal yellowing stability of the coating compositions.
^{[2]}: Initial yellowing, delta b at 30 and 50 μm.
^{[3]}: Overbake yellowing at 30 min 140° C./30 min 160° C.—delta b at different film thicknesses
^{[4]}: Total delta b=difference between two delta values
^{[5]}: Gloss as measured in accordance with DIN EN ISO 2813 before and after scratching according to DIN 55668; age of brush: 36 hours of operation. Measurement by means of reflectometer; the principle of the reflectometer is based on the measurement of directed reflection. For that purpose the intensity of the reflected light is measured in a narrow range of the reflection angle. ^{[8]}: The relative residual gloss in % indicates how high the gloss [20° incident angle] is after scratching in accordance with DIN 55668 in comparison to the gloss before scratching (NB: measurement transverse to the direction of scratching). The higher this figure, the better the scratch resistance.
^{[10]}: Solvent resistance: solvents used: X=xylene, MPA=methoxypropyl acetate, EA=ethyl acetate, Ac=acetone; exposure time 5 min, followed by visual assessment and classification according to 1 for no change and 5 for detachment of the coating film
^{[11-16]}: Tests were carried out for the resistance to tree resin, brake fluid, pancreatin (bird excrement), sodium hydroxide solution, sulphuric acid, and petroleum spirit.

In order to correspond to the realistic loads resulting from incoming solar radiation, the chemical resistances (apart from petroleum spirit; see item 5) were investigated at different temperatures (36° C. to 68° C.). For this purpose a gradient oven was available, model 2601 from BYK-Gardner, which allows continuous temperature settings from 30° C. to 250° C.

Sample Preparation for Investigations, in the Gradient Oven

Testing took place on steel panels (420 mm×98 mm×1 mm) which are produced especially for use in the gradient oven. Application again took place using a manual coater.

Supplier: Franz Krüppel—Industriebedarf, Postfach 13 04 36, Höffgeshofweg 17-19, 47807 Krefeld

The panels were cleaned thoroughly using xylene.

Coating composition:
surfacer, solvent-borne or aqueous
base coat, solvent-borne or aqueous (where necessary)
test clearcoat

The test panels are provided with paper strips from BYK-Gardner. At the bottom edge the strip marks the individual temperature points/heating segments (numbering from 1 to 45). The top paper strip allows a clear assignment of temperature and measurement point/heating segment.

Procedure

Testing was carried out under standard conditions (23° C., 50% relative humidity), since it is not possible entirely to rule out an influence of atmospheric humidity on the test results.

Setting of the gradient to 35° C. to 80° C.

Temperature difference: 1° K per heating segment

Constant gradient observable from 36° C. onwards

The test chemicals were applied, starting from 36° C., in accordance with the following scheme:

| | | | | Tem- | |
|---|---|---|---|---|---|
| | | Size of test | | perature | |
| Chemical | Solution form | spot | | interval | Supplier |
| Tree resin | as-supplied form | Ø 5 | mm | 2° C. | DuPont |
| Brake fluid | as-supplied form | Ø 5 | mm | 2° C. | BASF AG |
| Hydraulan | | | | | |
| 400 n.v. | | | | | |
| Pancreatin*) | 50% by weight in | Ø 5 | mm | 2° C. | Merck |
| | fully deionized | | | | |
| | water | | | | |
| Sodium | 1% by weight | about 25 | μl | 1° C. | |
| hydroxide | | | | | |
| solution | | | | | |
| (NaOH) | | | | | |
| Sulphuric | 1% by weight | about 25 | μl | 1° C. | |
| acid | | | | | |
| (H₂SO₄) | | | | | |

*)The original pancreatin substance should be stored with chilling (<15° C. according to manufacturer).

The pancreatin/water mixture must always be prepared fresh; the standing time of this solution should not be more than 4 hours.

Optimum application of the substances is achieved using the Eppendorf-Multipette 4780 with 25 μl tip (Eppendorf-COMBITIPS, 1.25 ml) or with the Eppendorf-Multipette plus 4980 with 25 μl tip (Eppendorf-COMBITIPS plus, 2.5 ml).

The duration between beginning of application and beginning of exposure in the oven should not exceed 10 minutes.

The prepared panel is subjected to thermal loading in the gradient oven at 36° C. to 68° C. (oven setting 35° C. to 80° C.) for 30 minutes. At the end of this time the panel must be cleaned, with tree resin and brake fluid first being removed with a soft cloth and white spirit thoroughly but gently. The remaining chemicals are to be washed off using hot water.

Assessment

The assessment is made after 1 hour and after 24 hours of storage under standard conditions (23° C., 50% relative humidity). Prior to visual assessment, any agents which have exuded must be removed using a cloth.

The test result stated for each chemical is the temperature value at which (without auxiliary means) the first visible damage occurs.

In summary it can be stated that topcoat compositions containing the blocked polyisocyanate according to the invention (coating compositions 2a to 2d) when compared to the comparison coating compositions containing DMP-blocked curatives (coating compositions 1a to 1d), demonstrated better film optical qualities, scratch resistance, sulphuric acid resistance and water resistance and also a substantially lower yellowing after UV curing plus thermal curing.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A blocked polyisocyanate containing at least one radiation-curable group and at least one structural unit of formula II) 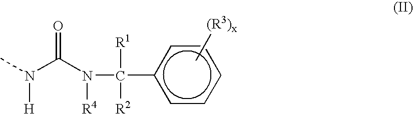
wherein
R¹, R² and R³ independently of one another are hydrogen, a C₁-C₄ alkyl radical or a cycloalkyl radical,
R⁴ is a C₁-C₄ alkyl, C₆-C₁₀ cycloalkyl or C₇-C₁₄ aralkyl radical and
x is an integer from 1 to 5.

2. The blocked polyisocyanate of claim 1 wherein said structural unit of formula II) is the reaction product of an isocyanate group with N-tert-butyl-N-benzylamine, N-isopropyl-N-benzylamine, N-ethyl-N-benzylamine, N-methyl-N-benzylamine or N-isopropyl-N-(dimethyl)benzylamine.

3. The blocked polyisocyanate of claim 1 wherein said structural unit of formula II) is the reaction product of an isocyanate group with N-tert-butyl-N-benzylamine.

4. The blocked polyisocyanate of claim 2 wherein said isocyanate group is from a polyisocyanate exclusively containing aliphatically and/or cycloaliphatically bound isocyanate groups.

5. The blocked polyisocyanate of claim 3 wherein said isocyanate group is from a polyisocyanate exclusively containing aliphatically and/or cycloaliphatically bound isocyanate groups.

6. A process for preparing a blocked polyisocyanate containing at least one radiation-curable group and at least one structural unit of formula II) 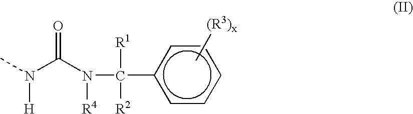
wherein
R¹, R² and R³ independently of one another are hydrogen, a C₁-C₄ alkyl radical or a cycloalkyl radical,
R⁴ is a C₁-C₄ alkyl, C₆-C₁₀ cycloalkyl or C₇-C₁₄ aralkyl radical and
x is an integer from 1 to 5,
which comprises reacting
A1) an organic polyisocyanate with
A2) a compound which contains at least one isocyanate-reactive group and at least one radiation-curable group,
A3) optionally an isocyanate-reactive compound other than A2) and
A4) a blocking agent of formula I) 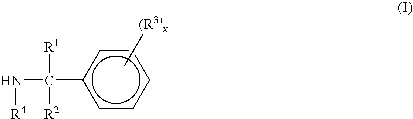
wherein
R¹, R² and R³ independently of one another are hydrogen, a C₁-C₄ alkyl radical or a cycloalkyl radical,
R⁴ is a C₁-C₄ alkyl, C₆-C₁₀ cycloalkyl or C₇-C₁₄ aralkyl radical and
x is an integer from 1 to 5.

7. The process of claim 6 wherein component A1) comprises a polyisocyanate or a mixture of polyisocyanates exclusively containing aliphatically and/or cycloaliphatically bound isocyanate groups.

8. The process of claim 6 wherein component A4) comprises N-tert-butyl-N-benzylamine, N-isopropyl-N-benzylamine, N-ethyl-N-benzylamine, N-methyl-N-benzylamine or N-isopropyl-N-(dimethyl)benzylamine.

9. The process of claim 7 wherein component A4) comprises N-tert-butyl-N-benzylamine, N-isopropyl-N-benzyl amine, N-ethyl-N-benzylamine, N-methyl-N-benzylamine or N-isopropyl-N-(dimethyl)benzylamine.

10. The process of claim 6 wherein component A4) comprises N-tert-butyl-N-benzylamine.

11. The process of claim 7 wherein component A4) comprises N-tert-butyl-N-benzylamine.

12. The process of claims 6 wherein 0.2 to 0.8 equivalents of A4) and 0.2 to 0.8 equivalents of A2) are used per equivalent of NCO in A1).

13. The process of claims 7 wherein 0.2 to 0.8 equivalents of A4) and 0.2 to 0.8 equivalents of A2) are used per equivalent of NCO in A1).

14. The process of claims 8 wherein 0.2 to 0.8 equivalents of A4) and 0.2 to 0.8 equivalents of A2) are used per equivalent of NCO in A1).

15. The process of claims 9 wherein 0.2 to 0.8 equivalents of A4) and 0.2 to 0.8 equivalents of A2) are used per equivalent of NCO in A1).

16. The process of claims 10 wherein 0.2 to 0.8 equivalents of A4) and 0.2 to 0.8 equivalents of A2) are used per equivalent of NCO in A1).

17. The process of claims 11 wherein 0.2 to 0.8 equivalents of A4) and 0.2 to 0.8 equivalents of A2) are used per equivalent of NCO in A1).

18. A dual-cure coating, adhesive or sealant composition containing the blocked polyisocyanate of claim 1.
